(19) United States
(12) Patent Application Publication
(10) Pub. No.: US 2011/0159317 A1
(43) Pub. Date: Jun. 30, 2011

(54) FLEXIBLE SHEET WITH HIGH MAGNETIC PERMEABILITY AND FABRICATION METHOD THEREOF

(76) Inventors: Mean-Jue TUNG, Kinmen County (TW); Wen-Song KO, Hsinchu City (TW); Yu-Ting HUANG, Hsinchu County (TW); Li-Chun WANG, Hsinchu County (TW)

(21) Appl. No.: 12/844,578

(22) Filed: Jul. 27, 2010

(30) Foreign Application Priority Data
Dec. 25, 2009 (TW) 98144939

(51) Int. Cl. G11B 5/74; C04B 35/645

(52) U.S. Cl. 428/835.6; 264/611

(57) ABSTRACT

A flexible sheet with high magnetic permeability is disclosed, including a magnetic ferrite sintering sheet including a plurality of pieces separated by micro gaps and a first flexible layer attached to a first side of the magnetic ferrite sintering sheet, wherein the pieces of the magnetic ferrite sintering sheet include a first protruding and recessing structure and a second protruding and recessing structure at opposite sides of one of the micro gaps, and the first protruding and recessing structure and the second protruding and recessing structure are matched with each other.

### CROSS REFERENCE

This Application claims priority of Taiwan Patent Application No. 98144939, filed on Dec. 25, 2009, the entirety of which is incorporated by reference herein.

### TECHNOLOGY FIELD

The disclosure generally relates to a technique for suppressing electromagnetic interference and more particularly to a flexible sheet with high magnetic permeability and fabrication method thereof.

### BACKGROUND

With the miniaturization of electrical circuits in communications, consumer electronics and computer technology, the suppressing of electromagnetic interference (EMI) has become increasingly important. EMI is type of noise interference which obstructs signals. The interference includes radiating noise from a source through space and conducting noise through conductive cables to interfere. Conducting noise is usually avoided using capacitors, inductors, EMI filters or EMI suppression sheets formed with a ring shape to act as an EMI core. Radiating noise is usually reduced by absorption using an EMI suppression sheet or reflection using a conductive sheet. In fact, EMI suppression sheets can be used to eliminate both radiating and conducting noises. Transmission integrated circuits in high speed signals, wiring and cables need to reduce radiating and conducting EMI noise by means of EMI suppression sheets.

A conventional flexible EMI suppression sheet with magnetic permeability is formed by the steps which comprise mixing and blending a magnetic powder material and a resin or a rubber to form a slurry or a gel and shaping using a doctor blade or pressing using a roller, to form a flexible sheet. The conventional EMI suppression sheet, however, has low magnetic permeability, due to the fact that it requires a certain percentage of resin or rubber. Therefore, the shielding effect of a conventional EMI suppression sheet is not good. In order to overcome the issue of low magnetic permeability, one method used is to change the magnetic powder material and another method used is to increase the filling ratio of the magnetic powder material. However, due to limitations, it is difficult to further increase the filling ratio of the magnetic powder material.

### SUMMARY

One embodiment relates to a flexible sheet with high magnetic permeability, including a magnetic ferrite sintering sheet including a plurality of pieces separated by micro gaps and a first flexible layer attached to a first side of the magnetic ferrite sintering sheet, wherein the pieces of the magnetic ferrite sintering sheet comprise a first protruding and recessing structure and a second protruding and recessing structure at opposite sides of one of the micro gaps, and the first protruding and recessing structure and the second protruding and recessing structure are matched with each other.

Another embodiment relates to a method for fabricating a flexible sheet with high magnetic permeability, including the steps of forming a magnetic ferrite sintering sheet, attaching a first flexible layer on a first side of the magnetic ferrite sintering sheet, and performing a hot pressing process, wherein the magnetic ferrite sintering sheet is crushed to a plurality of pieces during the hot pressing process.

### BRIEF DESCRIPTION OF DRAWINGS

The invention can be more fully understood by reading the subsequent detailed description and examples with references made to the accompanying drawings, wherein,

FIG. 1A and FIG. 1B are cross sections for illustrating a method for forming an EMI suppression sheet with high magnetic permeability.

FIG. 2 is a cross section of a flexible sheet with high magnetic permeability of an embodiment of the invention.

FIG. 3 is a local enlarged view of a flexible sheet with high magnetic permeability of an embodiment of the invention.

FIG. 4 is a cross section of a flexible sheet with high magnetic permeability of another embodiment of the invention.

FIG. 5 is a cross section of a flexible sheet with high magnetic permeability of further another embodiment of the invention.

FIG. 6 is a cross section of a flexible sheet with high magnetic permeability of yet another embodiment of the invention.

### DETAILED DESCRIPTION

In order to address the issue of low magnetic permeability, one of embodiments implements a sintering sheet of magnetic ferrite material as a principle part. A top layer, which is a glue layer comprising magnetic ferrite fine powders, is bonded onto the sintering sheet of magnetic ferrite material. A bottom layer, which is a glue layer comprising magnetic ferrite fine powders, is bonded onto the underside of the sintering sheet of magnetic ferrite material. The middle layer, the top layer and the bottom layer are then pressed to mold a sandwich structure. Following, a hot press hardening process is performed to form a flexible sheet with high magnetic permeability. The resulting flexible sheet has increased magnetic permeability and shield effect when compared to a conventional EMI suppression sheet.

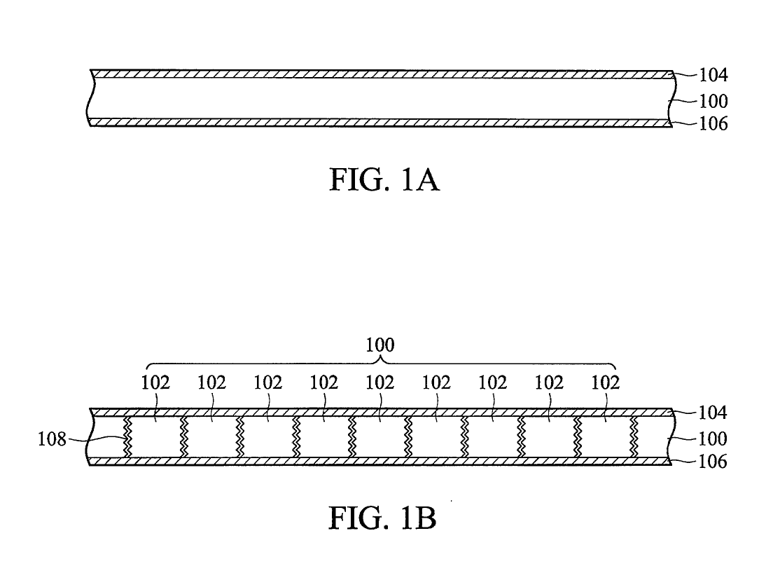

A method for forming an EMI suppression sheet with high magnetic permeability is illustrated in accordance with FIG. 1A and FIG. 1B. First, a magnetic ferrite material with high magnetic permeability is fabricated. Note that the invention includes, but is not limited to a specific magnetic ferrite material. Thus, in addition to iron oxide, also included may be Mn—Zn, Ni—Zn, Cu—Zn, Ni—Cu—Zn, Mg—Zn, and Li—Zn magnetic ferrite materials or combinations thereof. An example using Ni—Cu—Zn ferrite powder as the ferrite magnetic material is described in the following paragraphs. Iron oxide, nickel oxide, zinc oxide, and copper oxide are prepared with a specific ratio and then mixed, calcinated, ball grinded, sintered, and smashed to fabricate Ni—Cu—Zn ferrite fine powder. The Ni—Cu—Zn ferrite fine powder is then surface modified with a coupling agent to form a well-dispersed powder. Fabrication of magnetic ferrite materials is a known technique and those skilled in the art can refer to the following references: Journal of Zhejiang University SCIENCE ISSN 1009-3095, Science Letters, Preparation of high-permeability NiCuZn ferrite, Journal of Magnetism and Magnetic Materials 198 (1997) 285-291, Low temperature sintering of Ni—Zn—Cu ferrite and its permeability spectra, or 1997 American Institute of Physics [S0021-8979 (97) 07218-6] Magnetic field effect on the complex permeability. Next, the Ni—Cu—Zn ferrite powder is mixed and blended with a suitable resin, such as a modified epoxy resin adhesive, or a silicone to form an adhesive material comprising Ni—Cu—Zn ferrite fine powder. For example, 10-90 wt % of ferrite powder and 90-10 wt % of epoxy resin is used.

Thereafter, a step for forming a magnetic ferrite sintering sheet 100 is performed. In one embodiment, the Ni—Cu—Zn ferrite powder with high magnetic permeability is mixed with a binder, such as a polyvinyl butyral (PVB) resin or acrylic resin, to form a thick slurry, in which the mixing ratio can be 80-90 wt % of ferrite powder and 20-10 wt % of binder. Next, a doctor blade casting method is performed to form a green sheet. The green sheet is then debinded and sintered at a high temperature to form an Ni—Cu—Zn ferrite sintering sheet 100 which may have a thickness of about 30-150 μm, more preferably 30-100 μm.

A first flexible layer 104 and a second flexible layer 106 are attached onto a top surface and a bottom surface of the magnetic ferrite sintering sheet 100, respectively, to form a sandwich structure. Note that the invention includes, but is not limited to forming flexible layers both on the top surface and the bottom surface of the magnetic ferrite sintering sheet. In another embodiment of the invention, only the top surface or the bottom surface of the magnetic ferrite sintering sheet is attached with a flexible layer. In addition, the invention is not limited to a specific flexible layer. The flexible layer can be an adhesive film or a magnetic metal sheet, wherein the adhesive film can be any adhesive flexible material, such as polyvinyl chloride (PVC), polyurethane (PU), acrylic, hot-melt adhesive, epoxy resin, liquid silicone resin or combinations thereof. In one embodiment of the invention, the adhesive material of the top flexible layer and/or the bottom layer on the top side and/or the bottom side of the magnetic ferrite sintering sheet can be filled with magnetic powders, which can be a Fe—Ni—Co based metal powder, Mn—Zn, Ni—Zn, Cu—Zn, Ni—Cu—Zn, Mg—Zn, or Li—Zn ferrite materials or combinations thereof. In another embodiment, the adhesive film on the top side and/or the bottom side of the magnetic ferrite sintering sheet can be filled with a material with a high thermal conductivity coefficient, such as powders comprising Cu, Ag, Cu—Ag alloy, aluminum oxide or boron nitride. The fabricated EMI suppression sheet not only has high magnetic permeability, but also has a good heat dissipating effect. Therefore, the EMI suppression sheet can dissipate heat and suppress EMI.

Next, referring to FIG. 1B, a hot pressing process is performed, wherein the Ni—Zn—Cu ferrite sintering sheet 100 is crushed into a plurality of pieces 102 separated by gaps 108, wherein, a hot-press hardening step is performed to obtain the EMI suppression sheet with high magnetic permeability. In addition, the EMI suppression sheet can be further bent or press bent by a molding apparatus to form more pieces for increased flexibility of the EMI suppression sheet.

The EMI suppression sheet with high magnetic permeability can be applied in a device embedded substrate, a flexible inductor, a transformer, an EMI suppression device, a radio-frequency identification (RFID) tag and an EMI suppression sheet of electromagnetic parts or a magnetic shielding sheet. However, the invention is not limited thereto.

In one embodiment, because the pieces 102 of the magnetic ferrite sintering sheet 100 are formed from crushing during the hot pressing process, the pieces 102 have irregular shapes. In another embodiment of the invention, a pre-grooving step can be performed on the magnetic ferrite sintering sheet 100 before conducting the hot pressing process, wherein a plurality of grooves are formed on a surface of the ferrite sintering sheet 100. The ferrite sintering sheet 100 can be crushed along the grooves to form pieces with specific shapes during the hot pressing process. In an embodiment, length and width of the magnetic ferrite sintering sheet are within a range of between 0.5-5 mm, preferably 2-3 mm

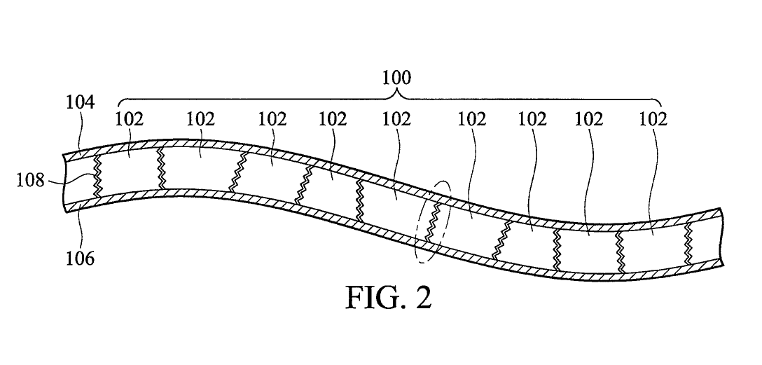

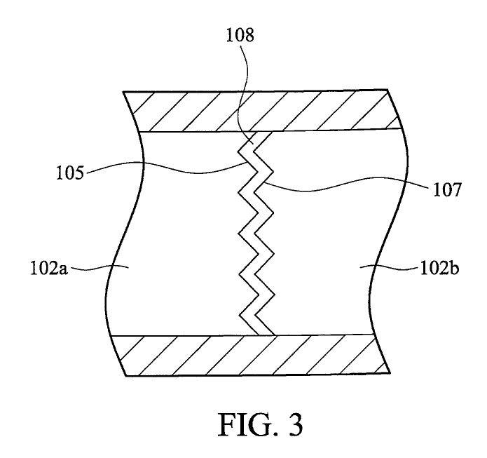

The flexible sheet with high magnetic permeability is illustrated in accordance with FIG. 2. As shown in FIG. 2, the top surface of the magnetic ferrite sintering sheet 100 is attached with a first flexible layer 104 and the bottom surface of the magnetic ferrite sintering sheet 100 is attached with a second flexible layer 106. The magnetic ferrite sintering sheet 100 is crushed into a plurality of pieces 102 by hot pressing process. Note that because the pieces 102 are formed from crushing of the magnetic ferrite sintering sheet 100 during the hot pressing process, the micro gap 108 between adjacent pieces 102 have irregular shapes. The micro gap between the pieces of the flexible sheet with high magnetic permeability is more clearly illustrated in accordance with FIG. 3 which is a local enlarged view of FIG. 2. Referring to FIG. 3, a micro gap 108 exists between a first piece 102a and a second piece 102b neighboring with each other. A side of the first piece 102a facing the micro gap 108 has a first protruding and recessing structure 105. A side of the second piece 102b facing the micro gap 108 has a second protruding and recessing structure 107. Because the pieces 102 are formed from crushing of the magnetic ferrite sintering sheet 100 during the hot pressing process, the first protruding and recessing structure 105 of the first piece 102a and the second protruding and recessing structure 107 of the second piece 102b are matched with each other, and the size of the micro gap can be very small, probably less than 10 um. That is, a protruding portion of the first protruding and recessing structure 105 of the first piece 102a corresponds to a recessing portion of the second protruding and recessing structure 107 of the second piece 102b, and a recessing portion of the first protruding and recessing structure 105 of the first piece 102a corresponds to a protruding portion of the second protruding and recessing structure 107 of the second piece 102b.

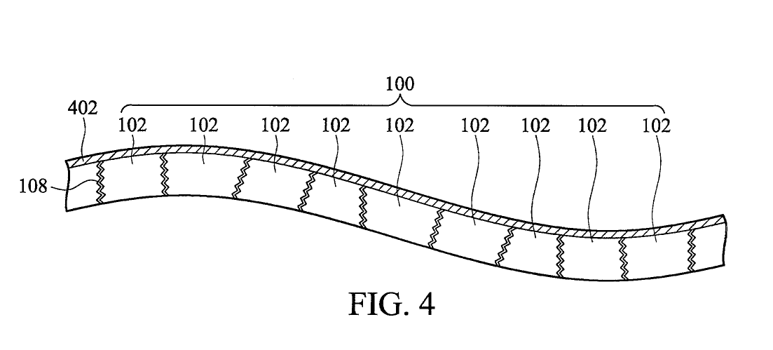

FIG. 4 shows a cross section of a flexible sheet with high magnetic permeability of another embodiment of the invention, wherein the like elements as previous figures use the same numbers. As shown in FIG. 4, the flexible sheet with high magnetic permeability of the embodiment comprises only one flexible layer 402 attached onto a top surface of the magnetic ferrite sintering sheet 100.

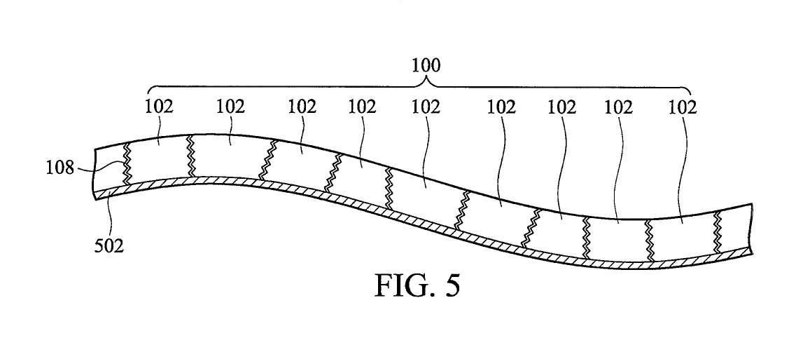

FIG. 5 shows a cross section of a flexible sheet with high magnetic permeability of further another embodiment of the invention. As shown in FIG. 5, the flexible sheet with high magnetic permeability of the embodiment comprises only one flexible layer 502 attached onto a bottom surface of the magnetic ferrite sintering sheet 100.

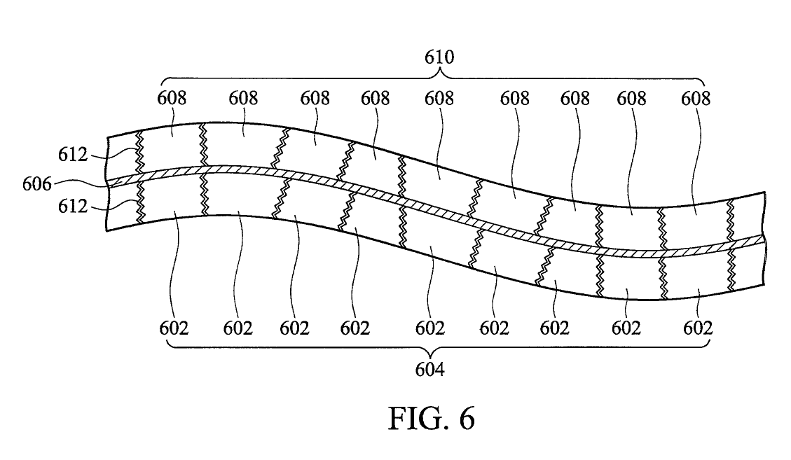

FIG. 6 shows a cross section of a flexible sheet with high magnetic permeability of yet another embodiment of the invention. As shown in FIG. 6, a first magnetic ferrite sintering sheet 604 is provided and a flexible layer 606 like the adhesive film previously described is attached onto the first magnetic ferrite sintering sheet 604. Next, a second magnetic ferrite sintering sheet 610 is attached onto the flexible layer 606. Thereafter, a hot pressing process is performed, wherein the first magnetic ferrite sintering sheet 604 and the second magnetic ferrite sintering sheet 610 are crushed into plurality of pieces 602, 608 separated by gaps 612.

### EXAMPLE 1

66 wt % of iron oxide, 4.7 wt % of nickel oxide, 22.7 wt % of zinc oxide, and 6.6 wt % of copper oxide were wet mixed, calcinated at 850° C., ball grinded, and dried to form a Ni—Cu—Zn ferrite powder. 88 wt % of the Ni—Cu—Zn ferrite powder and 12 wt % of PVB resin were mixed to form a thick liquid, and a doctor blade casting method was performed to fabricate a green sheet. Include mixing amounts of ferrite powder and PVB resin. The green sheet was then debinded and sintered at a high temperature of 1100° C. to form a Ni—Cu—Zn ferrite sintering sheet which had a thickness of 33 μm.

The ball grinded and dried Ni—Cu—Zn ferrite powder was then granulated, and sintered at 1100° C. and fine crushed to form a Ni—Cu—Zn ferrite fine powder. The Ni—Cu—Zn ferrite fine powder was then surface modified with a titanate coupling agent LICA38 to form a well-dispersed powder. 10 wt % of Ni—Cu—Zn ferrite powder and 90 wt % of a modified epoxy resin adhesive were mixed and blended to form an adhesive comprising the Ni—Cu—Zn ferrite fine powder.

Next, the adhesive was coated on a polyethylene terephthalate (PET) adhesive film having a releasing characteristic and the coating of the adhesive was controlled to form a layer thickness of about 10-20 μm. Thereafter, the top surface and the bottom surface of the Ni—Cu—Zn ferrite sintering sheet were attached with the PET adhesive film coated with the adhesive comprising the Ni—Cu—Zn ferrite powder, respectively, to form a sandwich structure. A hot pressing process was performed wherein the Ni—Cu—Zn ferrite sintering sheet was crushed into a plurality of pieces separated by micro gaps. Next, a hot-press hardening process was performed to complete an EMI suppression sheet with high magnetic permeability.

The EMI suppression sheet was measured using a RF Impedance/material analyzer apparatus showing high magnetic permeability 203 (at 1 MHz).

### EXAMPLE 2

65 wt % of iron oxide, 4.4 wt % of nickel oxide, 22.3 wt % of zinc oxide, and 8.3 wt % of copper oxide were wet mixed, calcinated at 850° C., ball grinded, and dried to form a Ni—Cu—Zn ferrite powder. 88 wt % of the Ni—Cu—Zn ferrite powder and 12 wt % of PVB resin were mixed to form a thick liquid, and a doctor blade casting method was performed to fabricate a green sheet. The green sheet was then debinded and sintered at a high temperature of 1100° C. to form a Ni—Cu—Zn ferrite sintering sheet having a thickness of 50 μm.

The ball grinded and dried Ni—Cu—Zn ferrite powder was then granulated, sintered at 1100° C. and fine crushed to form a Ni—Cu—Zn ferrite fine powder. The Ni—Cu—Zn ferrite fine powder was then surface modified with a titanate coupling agent LICA38 to form a well-dispersed powder. 10 wt % of Ni—Cu—Zn ferrite powder and 90 wt % of a modified epoxy resin adhesive were mixed and blended to form an adhesive comprising Ni—Cu—Zn ferrite fine powder.

Next, the adhesive was coated on a PET adhesive film having a releasing characteristic and the coating of the adhesive was controlled to form a layer thickness of about 10-20 μm. Thereafter, the top surface and the bottom surface of the Ni—Cu—Zn ferrite sintering sheet were attached with the PET adhesive film coated with the adhesive comprising the Ni—Cu—Zn ferrite powder, respectively, to form a sandwich structure. A hot pressing process was performed wherein the Ni—Cu—Zn ferrite sintering sheet was crushed into a plurality of pieces separated by micro gaps. Next, a hot-press hardening process was performed to complete an EMI suppression sheet with high magnetic permeability.

The EMI suppression sheet was measured using a RF Impedance/material analyzer apparatus showing high magnetic permeability 228 (at 1 MHz).

### EXAMPLE 3

65 wt % of iron oxide, 8.4 wt % of nickel oxide, 19.9 wt % of zinc oxide, and 6.7 wt % of copper oxide were wet mixed, calcinated at 750° C., ball grinded, and dried to form a Ni—Cu—Zn ferrite powder. 88 wt % of the Ni—Cu—Zn ferrite powder and 12 wt % of PVB resin were mixed to form a thick liquid, and a doctor blade casting method was performed to fabricate a green sheet. The green sheet was then debinded and sintered at a high temperature of 1050° C. to form a Ni—Cu—Zn ferrite sintering sheet which had a thickness of 52 μm.

The ball grinded and dried Ni—Cu—Zn ferrite powder was then granulated, sintered at 950° C. and fine crushed to form a Ni—Cu—Zn ferrite fine powder. The Ni—Cu—Zn ferrite fine powder was then surface modified with a titanate coupling agent LICA38 to form a well-dispersed powder. 10 wt % of Ni—Cu—Zn ferrite powder and 90 wt % of a modified epoxy resin adhesive were mixed and blended to form an adhesive comprising Ni—Cu—Zn ferrite fine powder.

Next, the adhesive was coated on a PET adhesive film having a releasing characteristic and the coating of the adhesive was controlled to form a layer thickness of 10-20 μm. Thereafter, the top surface and the bottom surface of the Ni—Cu—Zn ferrite sintering sheet were attached with the PET adhesive film coated with the adhesive comprising the Ni—Cu—Zn ferrite powder, respectively, to form a sandwich structure. A hot pressing process was performed wherein the Ni—Cu—Zn ferrite sintering sheet was crushed into a plurality of pieces separated by micro gaps. Next, a hot-press hardening process was performed to complete an EMI suppression sheet with high magnetic permeability.

The EMI suppression sheet was measured using a RF Impedance/material analyzer apparatus showing high magnetic permeability 140 (at 1 MHz).

While the invention has been described by way of example and in terms of the preferred embodiments, it is to be understood that the invention is not limited to the disclosed embodiments. It is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flexible sheet with high magnetic permeability, comprising:
a magnetic ferrite sintering sheet comprising a plurality of pieces separated by micro gaps, wherein the pieces of the magnetic ferrite sintering sheet comprise a first protruding and recessing structure and a second protruding and recessing structure at opposite sides of one of the micro gaps, wherein the first protruding and recessing structure and the second protruding and recessing structure are matched with each other; and
a first flexible layer attached to a first side of the magnetic ferrite sintering sheet.

2. The flexible sheet with high magnetic permeability as claimed in claim 1, wherein the protruding portion of the first protruding and recessing structure corresponds to the recessing portion of the second protruding and recessing structure of the second piece, and the recessing portion of the first protruding and recessing structure corresponds to the protruding portion of the second protruding and recessing structure.

3. The flexible sheet with high magnetic permeability as claimed in claim 1, further comprising a second flexible layer attached to a second side of the magnetic ferrite sintering sheet.

4. The flexible sheet with high magnetic permeability as claimed in claim 1, wherein the magnetic ferrite sintering sheet comprises Mn—Zn, Ni—Zn, Cu—Zn, Ni—Cu—Zn, Mg—Zn, Li—Zn ferrite material or combinations thereof.

5. The flexible sheet with high magnetic permeability as claimed in claim 1, wherein the first flexible layer is an adhesive film, and the adhesive film comprises polyvinyl chloride (PVC), polyurethane (PU), acrylic, hot-melt adhesive, epoxy resin, silicone resin or combinations thereof.

6. The flexible sheet with high magnetic permeability as claimed in claim 1, wherein the first flexible layer is a magnetic metal film.

7. The flexible sheet with high magnetic permeability as claimed in claim 5, wherein the adhesive film is filled with magnetic powders, wherein the magnetic powders comprise Fe—Ni—Co based metal powder, Mn—Zn, Ni—Zn, Cu—Zn, Ni—Cu—Zn, Mg—Zn, Li—Zn ferrite material or combinations thereof.

8. The flexible sheet with high magnetic permeability as claimed in claim 1, further comprising another magnetic ferrite sintering sheet attached to a side of the first flexible layer opposite to the magnetic ferrite sintering sheet.

9. The flexible sheet with high magnetic permeability as claimed in claim 1, wherein the length and the width of the pieces of the magnetic ferrite sintering sheet are within a range of between 0.5-5 mm.

10. The flexible sheet with high magnetic permeability as claimed in claim 1, wherein the flexible sheet with high magnetic permeability is applied to a device embedded substrate, a flexible inductor, a transformer, an electromagnetic interference (EMI) suppression device, a radio-frequency identification (RFID) tag and an EMI suppression sheet for electromagnetic parts or a magnetic shielding sheet.

11. A method for fabricating a flexible sheet with high magnetic permeability, comprising:
forming a magnetic ferrite sintering sheet;
attaching a first flexible layer on a first side of the magnetic ferrite sintering sheet; and
performing a hot pressing process, wherein the magnetic ferrite sintering sheet is crushed into a plurality of pieces during the hot pressing process.

12. The method for fabricating a flexible sheet with high magnetic permeability as claimed in claim 11, further comprising attaching a second flexible layer on a second side of the magnetic ferrite sintering sheet before performing the hot pressing process.

13. The method for fabricating a flexible sheet with high magnetic permeability as claimed in claim 11, further comprising pre-grooving the magnetic ferrite sintering sheet to form a plurality of grooves on the magnetic ferrite sintering sheet before performing the hot pressing process, such that the magnetic ferrite sintering sheet can be crushed and separated along the grooves during the hot pressing process.

14. The method for fabricating a flexible sheet with high magnetic permeability as claimed in claim 11, wherein the magnetic ferrite sintering sheet comprises Mn—Zn, Ni—Zn, Cu—Zn, Ni—Cu—Zn, Mg—Zn, Li—Zn ferrite material or combinations thereof.

15. The method for fabricating a flexible sheet with high magnetic permeability as claimed in claim 11, wherein the first flexible layer is an adhesive film, and the adhesive film comprises polyvinyl chloride (PVC), polyurethane (PU), acrylic, hot-melt adhesive, epoxy resin, liquid silicone resin or combinations thereof.

16. The method for fabricating a flexible sheet with high magnetic permeability as claimed in claim 11, wherein the first flexible layer is a magnetic metal film.

17. The method for fabricating a flexible sheet with high magnetic permeability as claimed in claim 15, wherein the adhesive film is filled with magnetic powders, and the magnetic powders comprise Fe—Ni—Co based metal powder, Mn—Zn, Ni—Zn, Cu—Zn, Ni—Cu—Zn, Mg—Zn, Li—Zn ferrite material or combinations thereof.

18. The method for fabricating a flexible sheet with high magnetic permeability as claimed in claim 11, further comprising attaching another magnetic ferrite sintering sheet on a side of the first flexible layer opposite to the magnetic ferrite sintering sheet before performing the hot pressing process.

19. The method for fabricating a flexible sheet with high magnetic permeability as claimed in claim 11, wherein the length and the width of the pieces of the magnetic ferrite sintering sheet are within a range of between 0.5-5 mm.

20. The method for fabricating a flexible sheet with high magnetic permeability as claimed in claim 11, wherein the flexible sheet with high magnetic permeability is applied to a device embedded substrate, a flexible inductor, a transformer, an electromagnetic interference (EMI) suppression device, a radio-frequency identification (RFID) tag and an EMI suppression sheet for electromagnetic parts or a magnetic shielding sheet.
